(19) United States
(12) Patent Application Publication
(10) Pub. No.: US 2004/0111247 A1
(43) Pub. Date: Jun. 10, 2004

(54) OPTIMIZATION OF TIMING MODELS USING BUS COMPRESSION

(75) Inventors: Paul Berevoescu, Mountain View, CA (US); Oleg Levitsky, San Jose, CA (US)

Correspondence Address: BEVER, HOFFMAN & HARMS, LLP, 1432 CONCANNON BLVD, BLDG G, LIVERMORE, CA, 94550-6006, US

(73) Assignee: Synopsys, Inc., Mountain View, CA (US)

(21) Appl. No.: 09/387,749

(22) Filed: Aug. 31, 1999

(51) Int. Cl. G06F 9/44

(52) U.S. Cl. 703/19

(57) ABSTRACT

### Abstract of the Disclosure

A method of compressing bus-related model data for transistor-level timing arcs in a circuit timing model. Compressed model syntax and timing information are provided for the following node-to-node transistor level representations: many-to-many bitwise, many-to-many, one-to-many, and many-to-one. In the many-to-many bitwise embodiment, each of the consecutive start nodes is coupled to a different end node. In the many-to-many embodiment, the plurality of consecutive transistor-level timing arcs have consecutive start nodes on a first bus and consecutive end nodes on a second bus, and each of the consecutive start nodes is coupled to each of the consecutive end nodes. In the many-to-one embodiment, the plurality of consecutive transistor-level timing arcs have consecutive start nodes on a first bus and a common end node on a second bus. In the one-to-many embodiment, the plurality of consecutive transistor-level timing arcs have a common start node on a first bus and consecutive end nodes on a second bus.

### Detailed Description of the Invention

### Background of Invention

A circuit timing analysis model takes a netlist and the associated timing information for a circuit, and abstracts them to get a representation of the circuit. The representation is then used by a circuit analyzer to estimate the overall performance of the circuit, identify critical paths in the circuit, and find timing violations. One prior art circuit analyzer is described by U.S. Patent Number 5,740,347, entitled "Circuit Analyzer of Black, Gray and Transparent Elements,"by Jacob Avidan, issued April 14, 1998, herein incorporated by reference in its entirety for all purposes.

At least in part due to the complexity of the circuits being designed, the 20 circuit analyzer can take a relatively long time to complete its analyses while consuming a large portion of memory and file space on a computer system. While it is desirable to incorporate efficiencies into the circuit model and analyzer in order to reduce the time, file space and memory required for the circuit analysis, it is also important to maintain the accuracy of the model.

One technique for accelerating circuit analyses and reducing memory requirements is bus compression. In the prior art, bus compression is performed at the gate level of a circuit, which can result in a loss of model accuracy. However, at the gate level, the loss of accuracy was not significantly felt in the circuit analysis, and so prior art gate-level bus compression techniques were considered adequate.

When a circuit analyzer is applied at the transistor level of a circuit (that is, at a level more detailed than the gate level), the complexity of the circuit model and analysis is increased. Thus, a transistor-level analysis can increase the amount of time and computer resources needed. It remains desirable to execute the transistor-level analyses as efficiently as possible, but without an attendant loss in accuracy. In fact, at the transistor level, a higher level of accuracy is desired for the circuit analysis. Therefore, prior art techniques that reduce accuracy, such as the gate-level bus compression technique mentioned above, are not adequate for a transistor-level analysis.

Accordingly, a need exists for a method to improve the efficiency (that is, for example, reduce the analysis time, file space and memory requirements) of circuit analyses at the transistor level. A need also exists for a method that addresses the above advantage and further provides the required level of accuracy for transistor-level circuit analyses. The present invention solves these needs. These and other objects and advantages of the present invention will become cleat to those of ordinary skill in the art in light of the following detailed description of the preferred embodiments which are illustrated in the various drawing figures.

### Summary of Invention

The present invention provides a method to improve the efficiency (that is, for example, reduce the analysis time, file space and memory requirements) of circuit analyses at the transistor level by compressing bus-related timing model information. The present invention also provides a method that provides an improved level of accuracy for transistor-level circuit analyses.

The present invention pertains to a method of compressing bus-related information for transistor-level timing arcs in a circuit timing model. In thepresent embodiment, timing information for a first transistor-level timing arc and timing information for a second transistor-level timing arc are compared. Figures of merit are calculated using the timing information for the first transistor-level timing arc and the timing information for the second transistor-level timing arc. The figures of merit are compared to a specified acceptance value. The first transistor-level timing arc and the second transistor-level timing arc are grouped when the figures of merit are acceptable. The first transistor-level timing arc and the second transistor-level timing arc are represented by a compressed transistor-level timing arc using a compressed syntax. The timing information for the first transistor-level timing arc and the timing information for the second transistor-level timing arc determine the bounding timing information for the compressed transistor-level timing arc.

In the present embodiment, a third transistor-level timing arc can be represented by the compressed transistor-level timing arc using the compressed syntax when the timing information for the third transistor-level timing arc is less than or equal to the bounding timing information.

In the present embodiment, when the timing information for the third transistor-level timing arc is greater than the bounding timing information, figures of merit are calculated using the timing information for the third transistor-level timing arc and the bounding timing information. These figures of merit are compared to the specified acceptance value. The third transistor-level timing arc can be grouped with the first transistor-level timing arc and the second transistor-level timing arc when these figures of merit are acceptable. The bounding timing information is revised for the compressed transistor-level timing arc using the timing information for the third transistor-level timing arc. The first, second and third transistor-level timing arcs can then be represented by the compressed transistor-level timing arc using the compressed syntax.

In its various embodiments, the present invention provides compressed model syntax and bounding timing information for the following node-to-node transistor level representations: many-to-many bitwise, many-to-many, one-to-many, and many-to-one. In the many-to-many bitwise embodiment, each of the consecutive start nodes is coupled to a different end node. In the many-to-many embodiment, the plurality of consecutive transistor-level timing arcs have consecutive start nodes on a first bus and consecutive end nodes on a second bus, and each of the consecutive start nodes is coupled to each of the consecutive end nodes. In the many-to-one embodiment, the plurality of consecutive transistor-level timing arcs have consecutive start nodes on a first bus and a common end node on a second bus. In the one-to-many embodiment, the plurality of consecutive transistor-level timing arcs have a common start node on a first bus and consecutive end nodes on a second bus.

In one embodiment, the timing information comprises each combination of transitions for a clock signal and/or a data signal. The timing information comprises delay times, or setup times and hold times, for each combination of transitions for a clock signal and/or a data signal.

In one embodiment, the figure of merit is the difference between the timing information for one transistor-level timing arc and the timing information for another transistor-level timing arc. In another embodiment, the figure of merit is the ratio of the timing information for one transistor-level timing arc and the timing information for another transistor-level timing arc.

In one embodiment, the acceptance value is specified by the user.

### Brief Description of Drawings

The accompanying drawings, which are incorporated in and form a part of this specification, illustrate embodiments of the invention and, together with the description, serve to explain the principles of the invention:FIGURE 1 is a block diagram of an exemplary computer system upon which embodiments of the present invention may be practiced.

FIGURE 2 is an illustration of clock and data signals used by a circuit timing model in accordance with one embodiment of the present invention.

FIGURES 3A, 3B, 3C and 3D illustrate node-to-node representations of circuits used in a circuit timing model in accordance with various embodiments of the present invention.

FIGURE 4 is a flowchart of steps in a process for compressing bus-related model data in a circuit timing model in accordance with one embodiment of the present invention.

### Detailed Description

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements symbols, characters, terms, numbers, or the like.

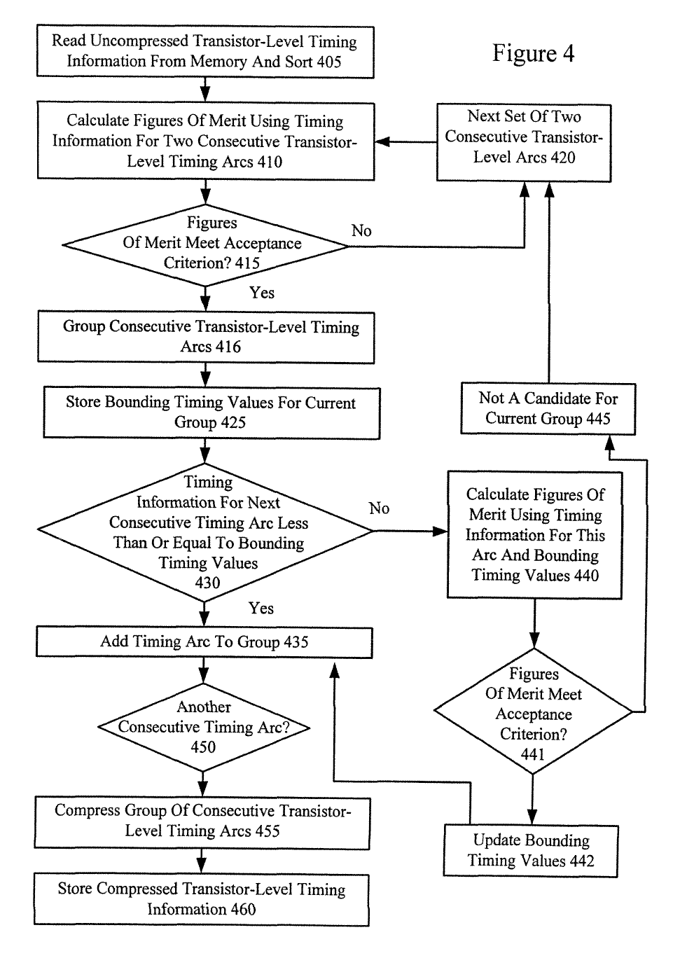

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as "comparing"or "calculating"or "representing"or "grouping" or the like, refer to the action and processes of a computer system (e.g., the process of Figure 4), or similar electronic computing device, that manipulates and transforms data represented as physical (electronic) quantities within the computer system"s registers and memories into other data similarly represented as physical quantities within the computer system memories or registers or other such information storage, transmission or display devices.

Refer now to Figure 1, which illustrates an exemplary computer system 190 upon which embodiments of the present invention may be practiced. In general, computer system 190 comprises bus 100 for communicating information, processor 101 coupled with bus 100 for processing information and instructions, random access (volatile) memory 102 coupled with bus 100 for storing information and instructions for processor 101, read-only (non-volatile) memory 103 coupled with bus 100 for storing static information and instructions for processor 101, data storage device 104 such as a magnetic or optical disk and disk drive coupled with bus 100 for storing information and instructions, an optional user output device such as display device 105 coupled to bus 100 for displaying information to the computer user, an optional user input device such as alphanumeric input device 106 including alphanumeric and function keys coupled to bus 100 for communicating information and command selections to processor 101, and an optional user input device such as cursor control device 107 coupled to bus 100 for communicating user input information and command selections to processor 101. Furthermore, an optional input/output (I/O) device 108 is used to couple the computer system 190 onto, for example, a network.

Display device 105 utilized with computer system 190 may be a liquid crystal device, cathode ray tube, or other display device suitable for creating graphic images and alphanumeric characters recognizable to the user. Cursor control device 107 allows the computer user to dynamically signal the two-dimensional movement of a visible symbol (pointer) on a display screen of display device 105. Many implementations of the cursor control device are known in the art including a trackball, mouse, joystick or special keys on alphanumeric input device 106 capable of signaling movement of a given direction or manner of displacement. It is to be appreciated that the cursor control 107 also may be directed and/or activated via input from the keyboard using special keys and key sequence commands. Alternatively, the cursor may be directed and/or activated via input from a number of specially adapted cursor directing devices.

The present invention pertains to a method of compressing bus-related transistor-level timing information (timing arcs) in a circuit timing model in a circuit analyzer. In accordance with the present invention, processor 101 executes the circuit analyzer stored as computer-readable instructions in random access (volatile) memory 102, read-only (non-volatile) memory 103, and/or data storage device 104. The circuit timing model can be used to estimate the overall performance of a circuit, identify critical paths in the circuit, and find timing violations. A circuit analyzer is described by U.S. Patent Number 5,740,347, entitled "Circuit Analyzer of Black, Gray and Transparent Elements," by Jacob Avidan, issued April 14,1998, herein incorporated by reference in its entirety for all purposes. However, it is appreciated that the present invention may be implemented using various circuit analyzers.

In accordance with the present invention, a circuit timing model (such as that described in the patent referenced above) calculates timing information for data paths comprised of nodes. In general, a node is a point of connectivity, including an input or output of the circuit. Each node is typically coupled to one or more other nodes (not shown) to represent a circuit in the circuit timing model. A data path starts at a user-defined start (or source) node, continues through a series of stages of combinatorial and/or sequential elements, and ends at an end (or sink) node. For each path, the circuit timing model accumulates delay times, setup times and hold times along the path.

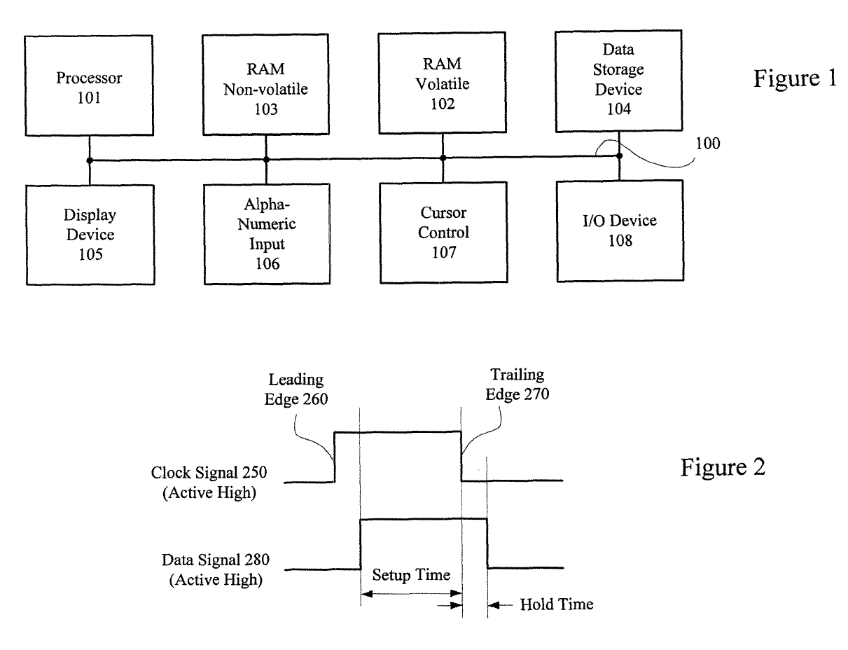

Figure 2 shows a clock signal 250 with leading edge 260 and trailing 10 edge 270. Also shown is data signal 280. Figure 2 shows a clock signal that is "active high;"that is, when clock signal 250 is at its higher value, then data can be latched. In a similar manner, clock signals can also be "active low." Due to the physical characteristics of the circuitry, data signal 280 must be available a certain amount of time before clock signal 250 transitions to its lower voltage (when active high) or its higher voltage (when active low). This time is called setup time. Data signal 280 must be available and constant for a certain amount of time after trailing edge 270 of clock signal 250 transitions; this time is called the hold time.

In the present embodiment, setup time calculations are based on each of the possible combinations of clock signal transitions and data signal transitions. Accordingly, there are eight possible combinations of transitions of a clock signal and setup time. Hold time is based only on the trailing edges of the clock signal, and so there are four possible combinations of transitions of a clock signal and hold time. Delay time calculations are based on all combinations of transitions of clock and/or data signals (that is, clock signal-to-clock signal, clock signal-to-data signal, data signal-to-clock signal, and data signal-to-data signal), and so there are eight possible combinations of transitions of clock and/or data signals.

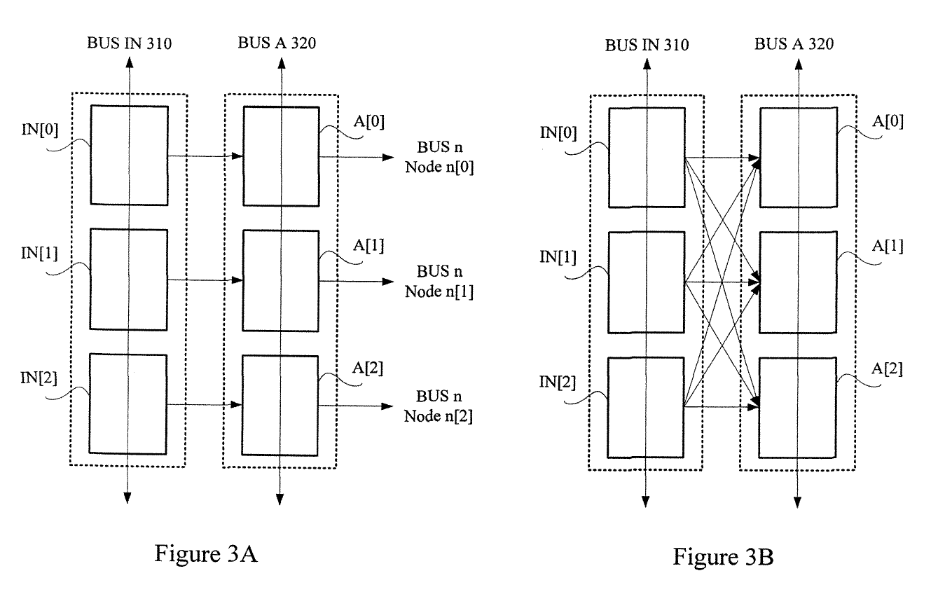

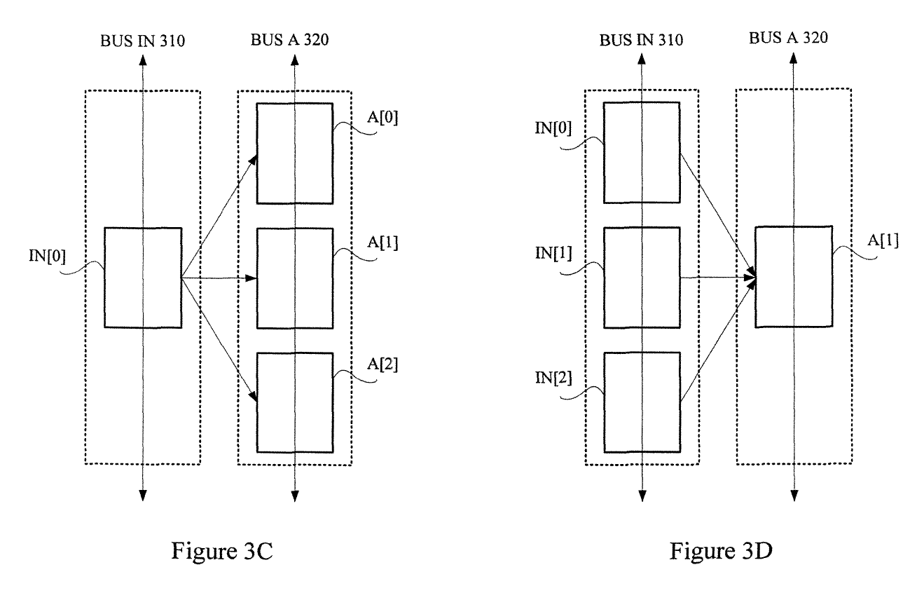

Figures 3A through 3D illustrate node-to-node representations of circuits used in a circuit timing model in accordance with the present invention. The representations of Figures 3A-D are at the transistor level. For the purpose of illustration clarity, only two buses with three or less nodes per bus are shown in each of Figures 3A-D; however, it is appreciated that additional buses and nodes may be represented and analyzed in accordance with the present invention.

In the present embodiment, each transistor-level node is identified by the name of the bus it resides on, a separator (such as brackets), and an index number indicating its relative position on the bus. For example, the first node on bus A 320 is identified as A[0]. Consecutive nodes on a bus are identified by consecutive index numbers. Consecutive nodes can be referred to using a combined form of their individual names; for example, the first three nodes on bus A 320 can be referred to as A[0-2].

A transistor-level timing arc can be referred to by its start node and its end node; for example, the transistor-level timing arc from lN[0] to A[0] can be identified as lN[0]→A[0]. Consecutive transistor-level timing arcs are those arcs with consecutive start nodes (or with the same start node) on one bus and consecutive end nodes (or the same end node) on another bus. For example, with reference to Figure 3A, the timing arcs identified as IN[0]→A[0] and lN[1]→A[1] are consecutive timing arcs. As another example, with reference to Figure 3C, IN[0]→A[0] and IN[0]→A[1] are also consecutive timing arcs.

Figure 3A illustrates a node-to-node transistor-level representation of a circuit referred to as many-to-many bitwise" in accordance with one embodiment of the present invention. In the many-to-many bitwise representation, there is only one path from one node on one bus to another node on another bus. For example, a single path exists between IN[0] on bus IN 310 and A[0] on bus A 320, a single path exists between IN[1] on bus IN 310 and A[1] on bus A 320, and so on. Thus, in the many-to-many bitwise representation, the number of start nodes is the same as the number of end nodes.

Figure 3B illustrates a node-to-node transistor-level representation of a circuit referred to as many-to-many" in accordance with one embodiment of the present invention. In the many-to-many representation, there is a path from every node on one bus to every node on another bus. For example, a path exists between IN[0] on bus IN 310 and A[0], A[1] and A[2] on bus A 320, another path exists between lN[1] on bus IN 310 and A[0], A[1] and A[2] on bus A 320, and so on. In the many-to-many representation, the number of start nodes and the number of end nodes may be different.

Figure 3C illustrates a node-to-node transistor-level representation of a circuit referred to as "one-to-many" in accordance with one embodiment of the present invention. In the one-to-many representation, there is a path from one node on one bus to every node on another bus. For example, a path exists between IN[0] on bus IN 310 and A[0], A[1] and A[2] on bus A 320.

Figure 3D illustrates a node-to-node transistor-level representation of a circuit referred to as "many-to-one"in accordance with one embodiment of the present invention. In the many-to-one representation, there is a path from every node on one bus to one node on another bus. For example, a path exists from IN[0], lN[1] and IN[2] on bus IN 310 to A[0] on bus A 320.

Figure 4 is a flowchart of one embodiment of the steps in a process 400 20 used for compressing the bus-related timing information for the node-to-node transistor-level representations of Figures 3A through 3D. Process 400 is implemented via computer-readable program instructions stored in a memory unit (e.g., random access memory 102, read-only memory 103, and/or data storage device 104) and executed by processor 101 of computer system 190 (Figure 1). In the present embodiment, process 400 is performed for the following node-to-node transistor-level representations: many-to-many bitwise, many-to-many, one-to-many, and many-to-one.

In the present embodiment, all of the timing information is considered before the compression is performed. That is, each possible combination of clock signal transition and/or data signal transition is considered (refer to discussion pertaining to Figure 2). As will be seen, the timing information is used to determine whether the consecutive transistor-level timing arcs can be compressed while still maintaining an acceptable level of accuracy. By considering all of the timing information, a high level of accuracy can be maintained. In addition, comparing the timing information before the compression is performed optimizes the circuit analysis model. By first identifying those transistor-level timing arcs that are candidates for compression, compression of timing arcs that will result in an unacceptable level of accuracy is avoided and does not have to be reversed.

In step 405 of Figure 4, in the present embodiment, the uncompressed transistor-level timing information is retrieved from computer system memory. In the present embodiment, the transistor-level timing arcs are sorted first on their start nodes and then on their end nodes.

In step 410, figures of merit are calculated using the uncompressed timing information (e.g., delay times, setup times, and hold times) for two consecutive transistor-level timing arcs, where a consecutive transistor-level timing arc is as defined above in conjunction with Figures 3A through 3D (e.g., many-to-many bitwise, many-to-many, one-to-many, and many-to-one). As described above, in the present embodiment, all of the uncompressed timing information is considered. In one embodiment, the figure of merit is the difference between the timing information for the two consecutive timing arcs. In another embodiment, the figure of merit is the ratio between the timing information for the two consecutive timing arcs. It is appreciated that, in other embodiments, other figures of merit may be used to compare timing information between transistor-level timing arcs.

In step 415 of Figure 4, the figures of merit calculated in step 410 are 15 compared to an acceptance criterion. In one embodiment, the acceptance criterion is a value specified by the user.

In step 416, if each of the figures of merit from step 410 satisfy the acceptance criterion, the two consecutive transistor-level timing arcs are grouped as candidates for bus compression.

In the present embodiment, each of the figures of merit must satisfy the acceptance criterion in order for the timing arcs to be considered as candidates for compression. By requiring that each figure of merit be acceptable before compression can be considered, a high level of accuracy can be maintained. In this manner, the behavior of the circuit analysis model with uncompressed transistor-level timing arcs is preserved when compressed transistor-leveltiming arcs are used in accordance with the present invention.

In step 420, if the figures of merit do not each satisfy the acceptance criterion, a new set of two consecutive transistor-level timing arcs are selected as initial candidates for bus compression. This new set of transistor-level timing arcs may include one of the transistor-level timing arcs from the preceding set. Steps 410 and 415 are repeated until a group of candidates for bus compression is formed.

In step 425, the bounding (e.g., worst) timing values for the two consecutive transistor-level timing arcs from steps 415 and 416 are stored for later use, as will be explained below.

In step 430, the uncompressed timing information (e.g., delay times, setup times, and hold times) for the next consecutive transistor-level timing arc is compared to the bounding timing values (from step 425) for the current group of candidates for bus compression.

In step 435, if the timing information for the next consecutive transistor-level timing arc is less than or equal to the bounding timing values for the current group of candidates for bus compression, the next consecutive transistor-level timing arc is added to the group.

In step 440, if the timing information for the next consecutive transistor-level timing arc is greater than the bounding timing values for the current group of candidates for bus compression, then figures of merit are determined using the timing information for the next consecutive transistor-level timing arc and the bounding timing values for the timing arcs currently in the group. In step 441, the figures of merit are compared to the acceptance criterion. If each figure of merit satisfies the acceptance criterion, then the next consecutive transistor-level timing arc is added to the group (step 435) and its timing information is used to determine new bounding timing values for the current group of candidates (step 442).

In step 445, if the figures of merit for a timing arc does not satisfy the acceptance criterion, then process 400 returns to steps 420 and 410 in order to form a next group of candidates for bus compression.

This portion of process 400 continues until there are no other transistor-level timing arcs left to consider (step 450).

For example, with reference to Figure 3A, the timing information for lN[1]→A[1] is compared to the timing information for lN[0]→A[0], and if the comparison satisfies the acceptance criterion, then these two transistor-level timing arcs are grouped. The bounding timing values for the group of lN[0]→A[0] and IN[1]→A[1] are stored.

Next, the timing information for IN[2]→A[2] is compared to the bounding timing values for the group of IN[0]→A[0] and IN[1]→A[1]. If the timing information for lN[2]→A[2] is less than or equal to the bounding timing values for the group of IN[0]→Aj~0] and lN[1]→A[1], then IN[2]→A[2] is added to the group. If the timing information for IN[2]→A[2] is greater than the bounding timing values for the group of IN[0]→A[0] and IN[1]→A[1], then figures of merit are determined by comparing the timing information for IN[2]→A[2] to the bounding timing values for IN[0]→A[0] and IN[1]→A[1]. If the figures of merit are each less than the acceptance criterion, then IN[2]→A[2] is added to the group and new bounding timing values are determined for the group now comprising lN[0]→A[0], lN[1]→A[1], and IN[2]→A[2].

Next, the timing information for IN[3]→A[3] is compared to the bounding timing values for the group of lN[0]→A[0], IN[1]→A[1], and IN[2]→A[2], and so on, until either a timing arc does not satisfy the acceptance criterion or there are no more timing arcs to consider. In the case in which a consecutive timing arc is arrived at that does not satisfy the acceptance criterion, that timing arc is not added to the group and the group is closed (that is, no more timing arcs can be added to the group). The latest timing arc (the timing arc that did not satisfy the acceptance criterion) and the next consecutive timing arc can then be used to start a new group.

In step 455 of Figure 4, each group of consecutive transistor-level timing arcs is compressed and represented by a single compressed transistor-level timing arc that uses the bounding timing values for the group. Thus, in accordance with the present invention, multiple transistor-level timing arcs are represented by a single timing arc and a single set of timing information, thereby reducing file space for storing timing information, memory requirements for processing this information, and the time needed for the circuit analyses.

In the present embodiment, the compressed transistor-level timing arc is identified by a combined form of the individual transistor-level timing arcs that it represents. For example, if IN[0]→A[0], IN[1]→A[1], and IN[2]→A[2] are compressed, then the compressed transistor-level timing arc is identified as lN[0-2]→A[0-2]. The timing information for IN[0]→A[0], lN[1]→A[1], and IN[2] →A[2] is provided by a single entry (or a single set of entries) corresponding to lN[0-2] →A10-2]. Thus, a simple syntax can be used to identify the compressed timing arc and to associate it with the transistor-level timing arcs that it represents. Hence, by considering only consecutive transistor-level timing arcs for compression, memory requirements are reduced and processing can be accelerated. For example, it is not necessary to introduce a roadmap of some sort in order to associate each transistor-level timing arc with a compressed timing arc. Instead, by considering consecutive transistor-level timing arcs, a simple syntax as described above can be used to identify the compressed timing arc and to associate it with the transistor-level timing arcs that it represents.

In step 460 of Figure 4, the compressed transistor-level timing information is stored in computer system memory. As part of the circuit analysis, when timing information is needed by the circuit analyzer for a particular path, the circuit timing model reads the syntax described above and retrieves the required data. For example, to retrieve timing information for IN[0]→A[0], the circuit analyzer recognizes that this timing arc is represented by lN[0-2]→A[0-2], and so uses that timing information. The circuit analyzer can repeatedly access lN[0-2 →A[0-2] for timing information for each transistor-level timing arc represented by that compressed timing arc. Thus, timing information can be readily retrieved in accordance with the present invention, further enhancing processing speed.

Table 1 provides examples of coding used in accordance with the present embodiment of the present invention for compression of bus-related timing information for the circuit representations illustrated by Figures 3A through 3D.

Table 1: Example Compression CodingMany-to-Many Bitwise (see Figure 3A)Compressed Arc: TABLEARC in[O-2] gray_model.intcell [3-5].intnode template=1This compressed arc means that the following paths are represented in the circuit timing model:in[O] -> gray_model.intcell[3].intnode template=lin[l] ->gray_model.intcell[4].intnode template=1in[2] -> gray_model.intcell[5].intnode template=lMany-to-Many (see Figure 3B)Compressed Arc: TAELEARC in[O-l] gray_model.intcell[3-5].intnode temp1ate=lThis compressed arc means that the following paths are represented in the circuit timing model:in[O] -> gray_model.intcell[3].intnode template=lin[O] -> gray_model.intcell[4].intnode template=linfO] -> gray_model.intcell[5].intnode template=lin[l] -> gray_model.intcell[3].intnode template=lin[l] -> gray_model.intcell[4].intnode template=lin[l] -> gray_model.intcell[5].intnode template=lOne-to-Many (see Figure 3C)Compressed Arc: TABLEARC in[O] gray_model.intcell[3-5].intnode template=lThis compressed arc means that the following paths are represented in the circuit timing model:in[O] -> gray_model.intcell[3].intnodein[O] -> gray_model.intcell[4] .intnodein[O] -> gray_model.intcell[5] .intnodeMany-to-One (see Figure 3D)Compressed Arc: TABLEARC in[O-2] gray_model.intcell[3].intnode template=lThis compressed arc means that the following paths are represented in the circuit timing model:in[O] -> gray_model.intcell[3].intnode template=lin[l] -> gray_model.intcell[3].intnode template=lin[2] ->gray_model.intcell[3].intnode template=lIn summary, the present invention provides a computer-implemented method of compressing bus-related timing information for consecutive transistor-level timing arcs in a circuit timing model. The present embodiment of the present invention preserves a desired accuracy level, and also introduces efficiencies into the circuit timing analysis model that can accelerate processing speed, and can reduce the amount of memory needed for processing and the amount of file space needed to store timing information.

Thus, the present invention provides a method to improve the efficiency (that is, for example, reduce the analysis time, file space and memory requirements) of circuit analyses at the transistor level. The present invention also provides a method that provides an improved level of accuracy for transistor-level circuit analyses.

The preferred embodiment of the present invention, optimization of timing models using bus compression, is thus described. While the present invention has been described in particular embodiments, it should be appreciated that the present invention should not be construed as limited by such embodiments, but rather construed according to the following claims.

What is Claimed is:

1.In a circuit timing model, a method of compressing bus-related model data for transistor-level timing arcs having a plurality of start nodes coupled to a plurality of end nodes, said method comprising the computer-implemented steps of:a) comparing timing information for a first transistor-level timing arc and timing information for a second transistor-level timing arc having consecutive start nodes on a first bus and consecutive end nodes on a second bus;b) calculating a figure of merit using said timing information for said first transistor-level timing arc and said timing information for said second transistor-level timing arc,
wherein said figure of merit is one of:
a difference between a first timing information associated with the first transistor-level timing arc and a second timing information associated with the second transistor-level timing arc; and
a ratio between the first timing information associated with the first transistor-level timing arc and the second timing information associated with the second transistor-level timing arc;
c) comparing said figure of merit to a specified acceptance value;
d) grouping said first transistor-level timing arc and said second transistor-level timing arc when said figure of merit is acceptable; ande) in a compressed circuit model, representing said first transistor-level timing arc and said second transistor-level timing arc by a compressed transistor-level timing arc, wherein said timing information for said first transistor-level timing arc and said timing information for said second transistor-level timing arc determine bounding timing information for said compressed transistor-level timing arc.

2.The method as recited in Claim 1 further comprising the step of:
f) in said compressed circuit model, representing a third transistor-level timing arc by said compressed transistor-level timing arc when timing information for said third transistor-level timing arc is less than or equal to said bounding timing information, wherein said second transistor-level timing arc and said third transistor-level timing arc have consecutive start nodes on said first bus and consecutive end nodes on said second bus.

3.The method as recited in Claim 2 further comprising the steps of:
g1) calculating a figure of merit using said timing information for said third transistor-level timing arc and said bounding timing information when said timing information for said third transistor-level timing arc is greater than said bounding timing information;
g2) comparing said figure of merit from said step gl) to said specified acceptance value;
g3) grouping said third transistor-level timing arc with said first transistor-level timing arc and said second transistor-level timing arc when said figure of merit from said step gl) is acceptable;
g4) revising said bounding timing information for said compressed transistor-level timing arc using said timing information for said third transistor-level timing arc; and
g5) representing said first, second and third transistor-level timing arcs by said compressed transistor-level timing arc.

4.The method as recited in Claim 3 wherein said figure of merit is a difference between a first timing information and a second timing information.

5.The method as recited in Claim 3 wherein said figure of merit is a ratio between a first timing information and a second timing information.

6.The method as recited in Claim 3 wherein timing information includes delay times.

7.The method as recited in Claim 3 wherein timing information includes setup times and hold times.

8.The method as recited in Claim 1 wherein each of said plurality of start nodes is coupled to each of said plurality of end nodes.

9.The method as recited in Claim 1 wherein each of said plurality of start nodes is coupled to a different end node.

10.n a circuit timing model, a method of compressing bus-related model data for transistor-level timing arcs having a plurality of start nodes coupled to a common end node, said method comprising the computer-implemented steps of:a) comparing timing information for a first transistor-level timing arc and timing information for a second transistor-level timing arc having consecutive start nodes on a first bus and a common end node on a second bus;b) calculating a figure of merit using said timing information for said first transistor-level timing arc and said timing information for said second transistor-level timing arc,
wherein said figure of merit is one of:
a difference between a first timing information associated with the first transistor-level timing arc and a second timing information associated with the second transistor-level timing arc; and
a ratio between the first timing information associated with the first transistor-level timing arc and the second timing information associated with the second transistor-level timing arc;
c) comparing said figure of merit to a specified acceptance value; d) grouping said first transistor-level timing arc and said second transistor-level timing arc when said figure of merit is acceptable; ande) in a compressed circuit model, representing said first transistor-level timing arc and said second transistor-level timing arc by a compressed transistor-level timing arc, wherein said timing information for said first transistor-level timing arc and said timing information for said second transistor-level timing arc determine bounding timing information for said compressed transistor-level timing arc.

11.The method as recited in Claim 10 further comprising the step of:
f) in said compressed circuit model, representing a third transistor-level timing arc by said compressed transistor-level timing arc when timing information for said third transistor-level timing arc is less than or equal to said bounding timing information, wherein said second transistor-level timing arc and said third transistor-level timing arc have consecutive start nodes on said first bus and a common end node on said second bus.

12.The method as recited in Claim 11 further comprising the steps of:
gl) calculating a figure of merit using said timing information for said third transistor-level timing arc and said bounding timing information when said timing information for said third transistor-level timing arc is greater than said bounding timing information;
g2) comparing said figure of merit from said step gl) to said specified acceptance value;
g3) grouping said third transistor-level timing arc with said first transistor-level timing arc and said second transistor-level timing arc when said figure of merit from said step gl) is acceptable;
g4) revising said bounding timing information for said compressed transistor-level timing arc using said timing information for said third transistor-level timing arc; and
g5) representing said first, second and third transistor-level timing arcs by said compressed transistor-level timing arc.

13.The method as recited in Claim 12 wherein said figure of merit is a difference between a first timing information and a second timing information.

14.The method as recited in Claim 12 wherein said figure of merit is a ratio between a first timing information and a second timing information.

15.The method as recited in Claim 12 wherein timing information includes delay times.

16.The method as recited in Claim 12 wherein timing information includes setup times and hold times.

17.In a circuit timing model, a method of compressing bus-related model data for transistor-level timing arcs having a common start node coupled to a plurality of end nodes, said method comprising the computer-implemented steps of:a) comparing timing information for a first transistor-level timing arc and timing information for a second transistor-level timing arc having a common start node on a first bus and consecutive end nodes on a second bus;b) calculating a figure of merit using said timing information for said first transistor-level timing arc and said timing information for said second transistor-level timing arc,
wherein said figure of merit is one of:
a difference between a first timing information associated with the first transistor-level timing arc and a second timing information associated with the second transistor-level timing arc; and
a ratio between the first timing information associated with the first transistor-level timing arc and the second timing information associated with the second transistor-level timing arc;
c) comparing said figure of merit to a specified acceptance value; d) grouping said first transistor-level timing arc and said second transistor-level timing arc when said figure of merit is acceptable; ande) in a compressed circuit model, representing said first transistor-level timing arc and said second transistor-level timing arc by a compressed transistor-level timing arc, wherein said timing information for said first transistor-level timing arc and said timing information for said second transistor-level timing arc determine bounding timing information for said compressed transistor-level timing arc.

18.The method as recited in Claim 17 further comprising the step of:
f) in said compressed circuit model, representing a third transistor-level timing arc by said compressed transistor-level timing arc when timing information for said third transistor-level timing arc is less than or equal to said bounding timing information, wherein said second transistor-level timing arc and said third transistor-level timing arc have a common start node on said first bus and consecutive end nodes on said second bus.

19.The method as recited in Claim 18 further comprising the steps of:
gl) calculating a figure of merit using said timing information for said third transistor-level timing arc and said bounding timing information when said timing information for said third transistor-level timing arc is greater than said bounding timing information;
g2) comparing said figure of merit from said step gl) to said specified acceptance value;
g3) grouping said third transistor-level timing arc with said first transistor-level timing arc and said second transistor-level timing arc when said figure of merit from said step gl) is acceptable;
g4) revising said bounding timing information for said compressed transistor-level timing arc using said timing information for said third transistor-level timing arc; and
g5) representing said first, second and third transistor-level timing arcs by said compressed transistor-level timing arc.

20.The method as recited in Claim 19 wherein said figure of merit is a difference between a first timing information and a second timing information.

21.The method as recited in Claim 19 wherein said figure of merit is a ratio between a first set of timing information and a second set of timing information.

22.The method as recited in Claim 19 wherein timing information includes delay times.

23.The method as recited in Claim 19 wherein timing information includes setup times and hold times.

24.A computer system comprising:an address/data bus;a processor coupled to said address/data bus;a computer-readable memory unit coupled to said address/data bus;said processor for performing a method of compressing bus-related model data for a plurality of transistor-level timing arcs, said method comprising the steps of:a) comparing timing information for a first transistor-level timing arc and timing information for a second transistor-level timing arc;b) calculating a figure of merit using said timing information for said first transistor-level timing arc and said timing information for said second transistor-level timing arc,
wherein said figure of merit is one of:
a difference between a first timing information associated with the first transistor-level timing arc and a second timing information associated with the second transistor-level timing arc; and
a ratio between the first timing information associated with the first transistor-level timing arc and the second timing information associated with the second transistor-level timing arc;
c) comparing said figure of merit to a specified acceptance value; d) grouping said first transistor-level timing arc and said second transistor-level timing arc when said figure of merit is acceptable;e) in a compressed circuit model, representing said first transistor-level timing arc and said second transistor-level timing arc by a compressed transistor-level timing arc, wherein said timing information for said first transistor-level timing arc and said timing information for said second transistor-level timing arc determine bounding timing information for said compressed transistor-level timing arc; andf) in said compressed circuit model, representing a third transistor-level timing arc by said compressed transistor-level timing arc when timing information for said third transistor-level timing arc is less than or equal to said bounding timing information.

25.The method as recited in Claim 24 further comprising the steps of:
gl) calculating a figure of merit using said timing information for said third transistor-level timing arc and said bounding timing information when said timing information for said third transistor-level timing arc is greater than said bounding timing information;
g2) comparing said figure of merit from said step gl) to said specified acceptance value;
g3) grouping said third transistor-level timing arc with said first transistor-level timing arc and said second transistor-level timing arc when said figure of merit from said step gl) is acceptable;
g4) revising said bounding timing information for said compressed transistor-level timing arc using said timing information for said third transistor-level timing arc; and
g5) representing said first, second and third transistor-level timing arcs by said compressed transistor-level timing arc.

26.The computer system of Claim 25 wherein said timing information includes delay times.

27.The computer system of Claim 25 wherein said timing information includes setup times and hold times.

28.The computer system of Claim 25 wherein said figure of merit is a difference between a first timing information and a second timing information.

29.The computer system of Claim 25 wherein said figure of merit is aratio between a first timing information and a second timing information.

30.The computer system of Claim 25 wherein said acceptance value is specified based on user input.

31.The computer system of Claim 24 wherein said plurality of consecutive transistor-level timing arcs have consecutive start nodes on a first bus and consecutive end nodes on a second bus, wherein each of said consecutive start nodes is coupled to each of said consecutive end nodes.

32.The computer system of Claim 24 wherein said plurality of consecutive transistor-level timing arcs have consecutive start nodes on a first bus and consecutive end nodes on a second bus, wherein each of said consecutive start nodes is coupled to a different end node.

33.The computer system of Claim 24 wherein said plurality of consecutive transistor-level timing arcs have consecutive start nodes on a first bus and a common end node on a second bus.

34.The computer system of Claim 24 wherein said plurality of consecutive transistor-level timing arcs have a common start node on a first bus and consecutive end nodes on a second bus.
